(19) United States
(12) Patent Application Publication
(10) Pub. No.: US 2014/0181042 A1
(43) Pub. Date: Jun. 26, 2014

(54) INFORMATION PROCESSOR, DISTRIBUTED DATABASE SYSTEM, AND BACKUP METHOD

(71) Applicant: Kabushiki Kaisha Toshiba, Tokyo (JP)

(72) Inventors: Haruhiko Toyama, Kawasaki-shi (JP); Akifumi Murata, Hino-shi (JP)

(73) Assignee: Kabushiki Kaisha Toshiba, Tokyo (JP)

(21) Appl. No.: 14/032,073

(22) Filed: Sep. 19, 2013

Related U.S. Application Data
(63) Continuation of application No. PCT/JP2013/058797, filed on Mar. 26, 2013.

(30) Foreign Application Priority Data
Dec. 26, 2012 (JP) 2012-283111

(51) Int. Cl. G06F 17/30

(52) U.S. Cl. CPC G06F 17/30289
USPC 707/652

(57) ABSTRACT

According to one embodiment, a apparatus includes a first module which stores update information includes position information indicating an update position in the data file in a first storage and data to be updated in a second storage, such that update information items includes the update information are stored in contiguous storage areas of the second storage in the order of request of each of the update information items when the data file is requested to be updated, and a second module which stores the update information items stored in the second storage in free space having contiguous addresses of a third storage, in the order of storing in the second storage, if an amount of the update information items in the second storage exceeds a set volume.

### CROSS-REFERENCE TO RELATED APPLICATIONS

This application is a Continuation Application of PCT Application No. PCT/JP2013/058797, filed Mar. 26, 2013 and based upon and claiming the benefit of priority from Japanese Patent Application No. 2012-283111, filed Dec. 26, 2012, the entire contents of all of which are incorporated herein by reference.

### FIELD

Embodiments described herein relate generally to a data backup technology suitable for a distributed database.

### BACKGROUND

Storage systems for storing a large amount of data and processing writing/reading of data at high speed have been developed variously. In this type of storage system, data backup for data integrity is very important.

A distributed database which improves the performance of data writing/reading by distributing data into a plurality of nodes and enhancing parallelism is a storage system. Generally, a host machine which requests the data writing/reading to a distributed database does not distinguish each of the nodes which constitutes the distributed database. Here, a machine which requests writing/reading of data to the distributed database is referred to as the host machine, and the host machine is not intended as the machine which is responsible for management of the distributed database.

There is a case where a distributed database file is stored by using storage devices at different levels of a hierarchy having different access speed. In backing up data by such storage devices, due to a difference in speed at each level of the hierarchy where access speed is uneven, it is difficult to efficiently collect update information for performing differential backup. In other words, with such storage devices, a backup by collecting up the entire data area was necessary.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary schematic diagram showing an example of a distributed database system configuration of an embodiment;

FIG. 2 is an exemplary block diagram showing a structure of an information processor according to the embodiment;

FIG. 3 is an exemplary block diagram showing a configuration of a distributed database system application program of FIG. 2;

FIG. 4 is an exemplary schematic diagram to be used for describing processing by a database management system application program; and

FIG. 5 is an exemplary schematic diagram to be used for describing processing by a database management system application program.

### DETAILED DESCRIPTION

Various embodiments will be described hereinafter with reference to the accompanying drawings.

In general, according to one embodiment, an information processing apparatus includes a first storage device, a second storage device, a first storing module, a third storage device, and a second storing module. The first storage device is configured to store a data file. The first storing module is configured to store update information item comprising position information indicating an update position in the data file and data to be updated in the second storage device, such that update information items comprising the update information item are stored in contiguous storage areas of the second storage device in the order of request of each of the update information items when the data file is requested to be updated. The second storing module is configured to store the update information items stored in the second storage device in free space having contiguous addresses of the third storage device, in the order of storing in the second storage device, if an amount of the update information items in the second storage device exceeds a set volume.

FIG. 1 shows a construction example of a distributed database system 100 in which an information processor of the present embodiment is applied as a node 10. As shown in FIG. 1, the distributed database system 100 is structured by a plurality of nodes 10 connected to data communication path A. Further, in structuring the distributed database system 100, there are various ways of structuring, such as (a) adopting one of the plurality of nodes 10 as a master, and have the selected node 10 manage control of the entire distributed database system 100, (b) making the plurality of nodes 10 operate independently as members of the distributed database system 100 on the same footing in accordance with predetermined rules, and (c) providing a host node which manages control of the entire distributed database system 100 separately from the plurality of nodes 10. However, a mechanism of data backup to be described later is not limited to any of the above methods.

Now, it is assumed that a request is made to the distributed database system 100 from a host machine 1 to read data. In case (a), the request from the host machine 1 is accepted by the node 10 serving as the master, and the node 10 having the data is determined. If the master node 10 does not store the data, the request is transmitted to the data holding node 10. In case (b), each of the nodes 10 accepts the request from the host machine 1, and judges whether the data in question is stored in their own nodes. One of the nodes 10 which judges that the data is stored in its own node executes the reading processing. Further, in case (c), the request from the host machine 1 is accepted by the host node, and a judgment is made as to which node 10 has the data and the request is transmitted to the data holding node 10.

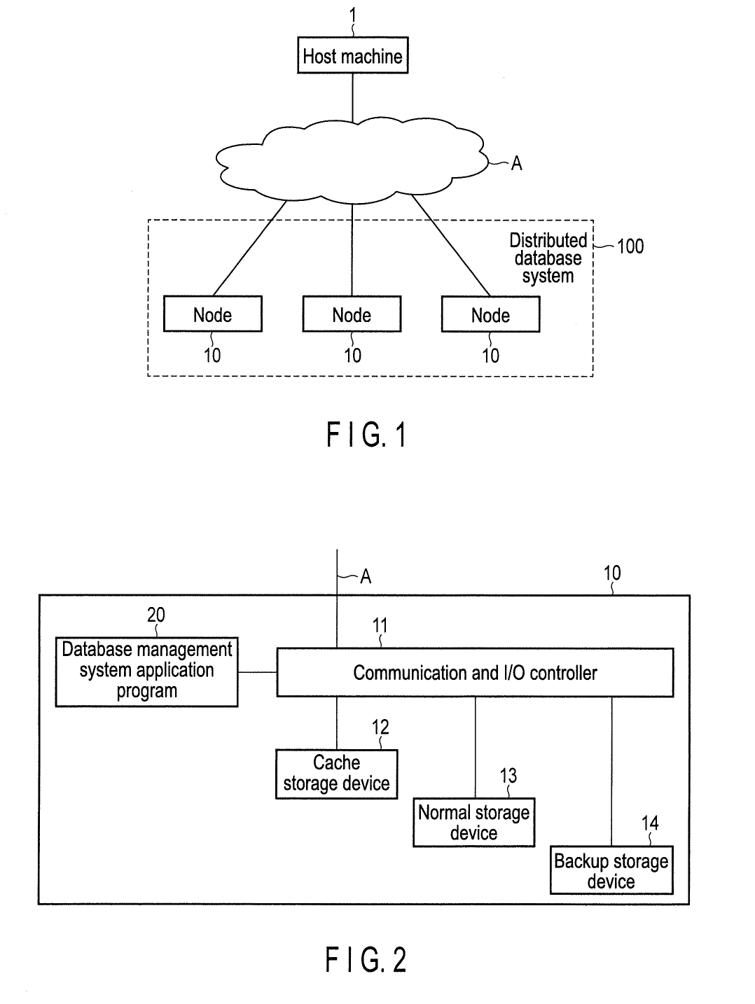

Further, as shown in FIG. 2, the node 10 comprises a communication and I/O controller 11, a cache storage device 12, a normal storage device 13, and a backup storage device 14. The communication and I/O controller 11 is a device which manages control of the node 10, and primarily has the function of executing communication with the other node 10. Further, the node 10 comprises a central processing unit (CPU) for executing a database management system application program 20. The database management system application program 20 is a program for managing a distributed database.

The database management system application program 20 updates a distributed database file based on a request from the host machine 1 received by the communication and I/O controller 11. Further, the database management system application program 20 reads data from the distributed database file based on the request from the host machine 1 received by the communication and I/O controller 11, and transmits the data which has been read.

Three hierarchical levels are structured by the cache storage device 12, the normal storage device 13, and the backup storage device 14. A random access speed of the cache storage device 12 is the highest of the three types of the storage devices. A random access speed of the normal storage device 13 is lower than that of the cache storage device 12. The backup storage device 14 may not have a random-access capability, and even if it has the random-access capability, a random access speed is lower than that of the normal storage device 13. A sequential access speed of the normal storage device 13 or the backup storage device 15 is substantially the same as that of the cache storage device 12 or higher than that of the cache storage device 12. Even if the sequential access speed is low, it is not as low as the random access capability.

The normal storage device 13 stores the distributed database file and partitioning information. The entire database file is divided as partitions. The distributed database file constitutes the database file divided as partitions. The distributed database file is a part of the database file. The partitioning information includes information indicating the node in which each of the divided partitions (each distributed database file) is stored.

Each node 10 includes status information of the entire distributed database system 100 and the partitioning information, and these kinds of information are synchronized in the distributed database system 100 by a communication function of the communication and I/O controller 11. The partitioning information is the information showing which node 10 includes each partition prepared by dividing the storage area of the entire distributed database system 100.

Further, in the partitioning information, an index, which enhances efficiency of random reference processing or access to a record in a constant order, may be created for one or more columns in the distributed database file (table). The index has a data structure for speeding up processing to the distributed database file.

Also, statistical information summarizing the distributed database file and a property of the index (data size, distribution of data, etc.) may be included in the partitioning information. The statistical information includes statistics on the table, such as the size of the table, the number of rows, and an average size per row. Further, the statistical information includes statistics on the columns in the table, such as the number of types of column data, and a data distribution (histogram). Furthermore, the statistical information includes statistics on the index, such as the size of the index, the number of hierarchical levels, and a clustering coefficient. The statistical information also includes statistics on the system (node), such as an input/output (I/O) of a server and throughput of the CPU.

The communication and I/O controller 11 secondarily has the function of controlling data input-output for the cache storage device 12, the normal storage device 13, and the backup storage device 14.

More specifically, the communication and I/O controller 11 executes reading of data from the cache storage device 12, the normal storage device 13, and the backup storage device 14, and writing of data in the same based on a request from the database management system application program 20.

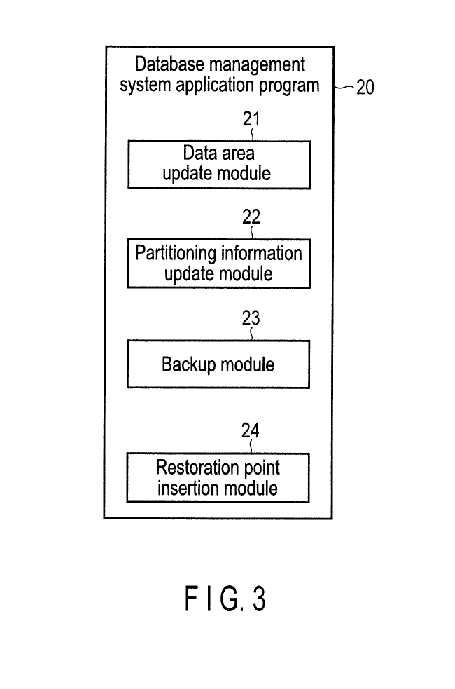

FIG. 3 is a block diagram showing a configuration of the database management system application program 20.

The database management system application program 20 comprises a data area update module 21, a partitioning information update module 22, a backup module 23, a restoration point insertion module 24, etc.

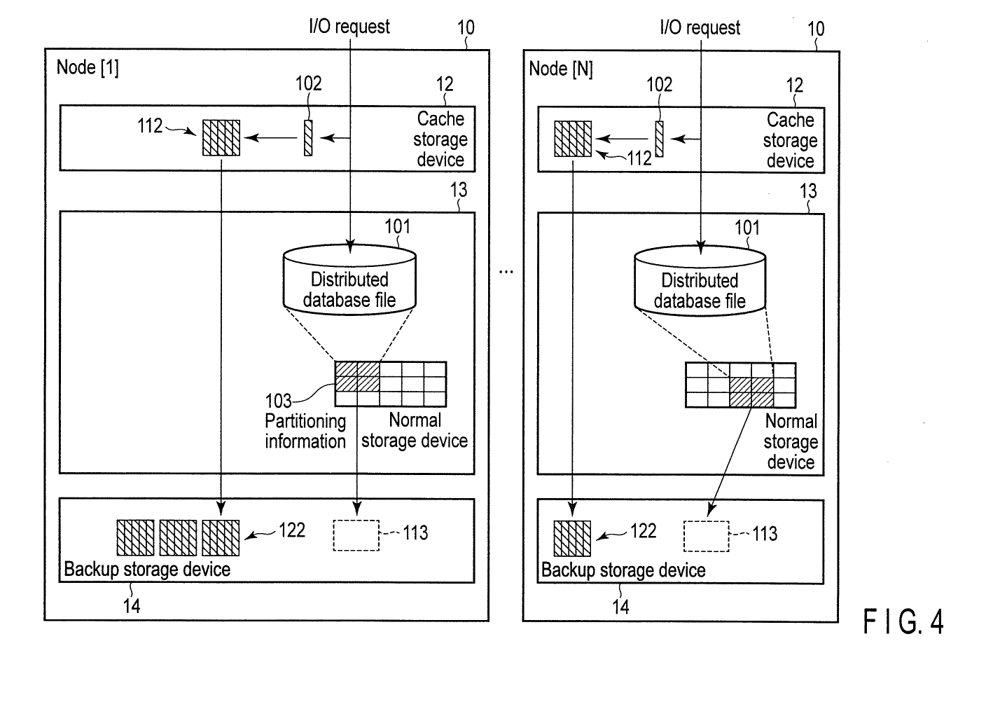

FIG. 4 is a schematic diagram for describing processing by the database management system application program 20.

The data area update module 21 is configured to update a distributed database file 101 in the normal storage device 13 in response to an update request from the host machine 1. The data area update module 21 is configured to store the update request in the cache storage device 12 as update information 102. Update information is written in the cache storage device if there was access to the node to request an update of data in the distributed database file of that node. Data update information comprises position information indicating an update position in the distributed data file and data to be updated.

The data area update module 21 is configured to store the update information 102 in free space having contiguous addresses of the cache storage device 12. Preferably, the data area update module 21 should write information in contiguous storage areas in an ascending order of address numbers of an area in which no data is stored in the cache storage device 12. By writing the update information in the contiguous storage areas in the ascending order of address numbers of the area in which no data is stored in the cache storage device 12, a plurality of items of the update information are contiguously stored in the order of access in the cache storage device.

The partitioning information update module 22 is configured to update partitioning information 103 regularly according to the distributed database file.

If an amount of a plurality of items of update information 112 in the cache storage device 12 or the number of items of update information becomes greater than a set value, the backup module 23 copies the plurality of items of update information 112 in the cache storage device 12 to the backup storage device 14 (reference numeral 122 of FIG. 4). The backup module 23 reads the update information from the storage areas storing the plurality of items of update information 112 in the cache storage device 12 in a sequential order from the initial address, and copies the read update information to the backup storage device 14. Since the update information is stored in the order of access, even if the backup module 23 does not know the order of access, access is allowed in the order of access of the update information.

In copying, the backup module 23 copies the update information in free space having contiguous addresses of the backup storage device 14. Preferably, the backup module 23 should write update information in contiguous storage areas in an ascending order of address numbers of an area in which no data is stored in the backup storage device 14. By writing the update information in the contiguous storage areas in the ascending order of address numbers of the area in which no data is stored in the backup storage device 14, a plurality of items of update information are contiguously stored in the backup storage device 14.

After copying, the backup module 23 is configured to erase the update information 112 in a high-speed cache area. In erasing, the backup module 23 generates a backup file 113 of the partitioning information by copying the partitioning information 103 in the backup storage device 14.

Further, a plurality of partitions may be set in the backup storage device 14 so that a partition in which the partitioning information 113 is stored and a partition in which a plurality of items of update information 122 are stored can be separated. Furthermore, a different backup storage device for the partitioning information 113 may be prepared to have the partitioning information 113 stored in the different backup storage device.

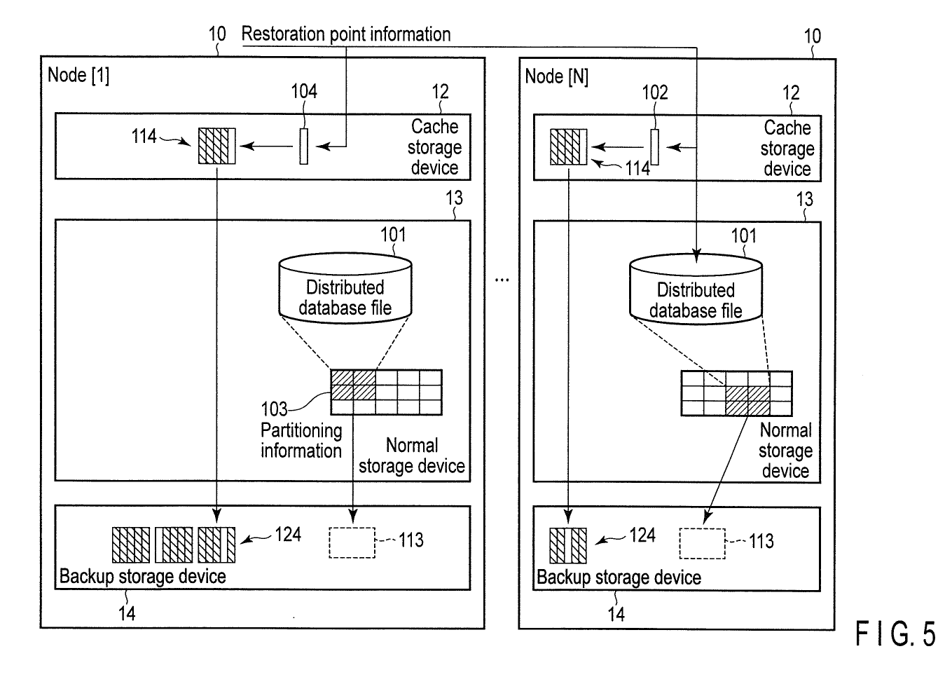

FIG. 5 is a schematic diagram for describing processing by the database management system application program 20.

Further, in order to designate a restoration point, restoration point information is transmitted to each node from the host machine 1, the master node, or the host node, for example, regularly or by an administrator's instruction.

In receiving the restoration point information, the restoration point insertion module 24 of each node is configured to write restoration point information 104 in free space having contiguous addresses in the cache storage device 12. Preferably, the restoration point information 104 should be written in contiguous storage areas in an ascending order of address numbers of an area in which no data is stored in the backup storage device 14.

In copying the update information in the cache storage device 12 to the backup storage device 14, the backup module 23 also copies the restoration point information. The backup module 23 is configured to copy the restoration point information in free space having contiguous addresses of the backup storage device 14. The backup module 23 reads the update information from the storage areas where the plurality of items of update information 112 and the restoration point information 104 are stored in the cache storage device 12 in a sequential order from the initial address, and copies the same to the backup storage device 14. Since the update information 112 and the restoration point information 104 are stored in the order of access, even if the backup module 23 does not know the order of access, the update information 112 and the restoration point information 104 can be accessed in the order of access.

Preferably, the backup module 23 should write the update information and the restoration point information in contiguous storage areas in an ascending order of address numbers of an area in which no data is stored in the backup storage device 14. By writing the restoration point information in the contiguous storage areas in the ascending order of address numbers of the area in which no data is stored in the backup storage device 14, a plurality of items of the update information and the restoration point information are contiguously stored in the backup storage device 14.

In the above procedure, a backup is obtained by reading the update information from the storage areas where the update information 112 and the restoration point information 104 are stored of the cache storage device 12 in a sequential order from the initial address, and copying the same to the backup storage device 14. By doing so, it becomes possible to obtain a differential backup efficiently while maintaining a high-speed feature of the hierarchical storage devices.

Further, since the data stored in the cache storage device is not changed by the backup, it becomes possible to carry out a backup method which does not affect the performance of the distributed database system 100.

The steps of restoring the distributed database file based on the backup data stored in the backup storage device 14 are reproduced by successively applying the update information stored in the contiguous areas of the backup storage device 14 to the designated restoration point.

Instead of storing all items of the update information, only the memory location in the normal storage device 13 may be stored in the cache storage device 12 so that the relevant data is copied to the backup storage device 14 from the normal storage device 13 based on the memory location instead of copying all items of the update information to the backup storage device 14. By doing so, a differential backup in which the capacity of the cache storage device 12 is saved is enabled.

Since all of the steps of storing data in accordance with an update request for data and the steps of data backup of the present embodiment can be realized by software, by installing this software into an ordinary computer through a computer-readable storage medium, an advantage similar to the advantage obtained by the present embodiment can be easily realized.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first storage device configured to store a data file;
a second storage device;
a first storing module configured to store update information item comprising position information indicating an update position in the data file and data to be updated in the second storage device, such that update information items are stored in contiguous storage areas of the second storage device in the order of request of each of the update information items when the data file is requested to be updated;
a third storage device; and
a second storing module configured to store the update information items stored in the second storage device in free space having contiguous addresses of the third storage device, in the order of storing in the second storage device, if an amount of the update information items in the second storage device exceeds a set volume.

2. The apparatus of claim 1, further comprising a third storing module configured to store restoration point information item indicating a restoration point in a first storage area if the restoration point information is received, wherein the first storage area is located after a second storage area of the second storage device where the last-requested update information item is stored and contiguous with the second storage area.

3. The apparatus of claim 2, wherein the second storing module is configured to store the update information items and restoration point information items stored in the second storage device in free space having contiguous addresses of the third storage device in the order of storage in the second storage device if an amount of data stored in the second storage device exceeds a set volume.

4. The apparatus of claim 1, wherein the second storing module is configured to store information based on the data file in a fourth storage device if the amount or the number of items of the update information items stored in the second storage device exceeds a set value.

5. The apparatus of claim 1, wherein
a random access speed of the second storage device is higher than a random access speed of the first storage device or of the third storage device, and
the random access speed of the third storage device is lower than the random access speed of the first storage device.

6. A distributed database system connected to a network and comprising information processing apparatuses for structuring a distributed database, each of the information processing apparatuses comprising:
a first storage device configured to store a distributed database file which is a part of a database file divided as partitions;
a second storage device;
a first storing module configured to store update information item comprising position information indicating an update position in the distributed database file and data to be updated in the second storage device, such that update information items are stored in contiguous storage areas of the second storage device in the order of request of each of the update information items when the distributed database file is requested to be updated;
a third storage device; and
a second storing module configured to store the update information stored in the second storage device in free space having contiguous addresses of the third storage device, in the order of storing in the second storage device, if an amount of the first update information items in the second storage device exceeds a set volume.

7. The system of claim 6, further comprising a third storing module configured to store restoration point information item indicating a restoration point in a first storage area if the restoration point information is received, wherein the first storage area is located after a second storage area of the second storage device where the last-requested update information item is stored and contiguous with the second storage area.

8. The system of claim 7, wherein the second storing module is configured to store second update information items and restoration point information items stored in the second storage device in free space having contiguous addresses of the third storage device in the order of storage in the second storage device if an amount of data stored in the second storage device exceeds a set volume.

9. The system of claim 6, wherein the second storing module is configured to store information based on the data file in a fourth storage device if the amount or the number of items of the update information stored in the second storage device exceeds a set value.

10. The system of claim 6, wherein
a random access speed of the second storage device is higher than a random access speed of the first storage device or of the third storage device, and
the random access speed of the third storage device is lower than the random access speed of the first storage device.

11. A backup method in a distributed database system connected to a network and comprising a plurality of information processors for structuring a distributed database, the backup method executed by each of the plurality of information processors comprising a first storage device configured to store a distributed database file, which is a part of a database file divided as partitions, the method comprising:
storing update information item comprising position information indicating an update position in the data file and data to be updated in a second storage device, such that update information items are stored in contiguous storage areas of the second storage device in the order of request of each of the update information items when the data file is requested to be updated; and
storing the update information items stored in the second storage device in free space having contiguous addresses of a third storage device, in the order of storing in the second storage device, if an amount of the update information items stored in the second storage device exceeds a set volume.

12. The method of claim 11, further comprising storing restoration point information item indicating a restoration point in a first storage area if the restoration point information is received, wherein the first storage area is located after a second storage area of the second storage device where the last-requested update information item is stored and contiguous with the second storage area.

13. The method of claim 12, further comprising storing second update information items and restoration point information items stored in the second storage device in free space having contiguous addresses of the third storage device in the order of storage in the second storage device if an amount of data stored in the second storage device exceeds a set volume.

14. The method of claim 11, further comprising storing information based on the distributed database file in a fourth storage device if the amount or the number of items of the update information stored in the second storage device exceeds a set value.

15. The method claim 11, wherein
a random access speed of the second storage device is higher than a random access speed of the first storage device or of the third storage device, and
the random access speed of the third storage device is lower than the random access speed of the first storage device.
